(19) United States
(12) Patent Application Publication
(10) Pub. No.: US 2025/0296248 A1
(43) Pub. Date: Sep. 25, 2025

(54) FIXTURE, ROBOTIC FIXTURE INCLUDING THE SAME, AND A METHOD FOR CLAMPING A TURNOVER BOX

(71) Applicant: ABB SCHWEIZ AG, Baden (CH)

(72) Inventors: Haoteng Lei, Shanghai (CN); Bojun Ma, Shanghai (CN); Dilong Yu, Shanghai (CN); Yin Tian, Shanghai (CN)

(21) Appl. No.: 19/229,405

(22) Filed: Jun. 5, 2025

Related U.S. Application Data
(63) Continuation of application No. PCT/CN2022/136707, filed on Dec. 5, 2022.

(51) Int. Cl. B25J 15/02; B25J 9/16; B25J 19/02

(52) U.S. Cl. CPC B25J 15/0286; B25J 9/1653; B25J 19/023

(57) ABSTRACT

Embodiments of the present disclosure generally relate to a fixture, a robotic fixture including the same, and a method for clamping the turnover box. A fixture comprising: an corner fixture assembly configured to support the turnover box at the top corner of the turnover box; a drive mechanism including a first drive rail and a second drive rail; a first side fixture assembly movable along the first drive rail and a second side fixture assembly movable along the second drive rail, the first side fixture assembly and the second side fixture assembly configured to support the turnover box at a side wall of the turnover box adjacent the top corner, respectively. Embodiments of the present disclosure provide a fixture with an asymmetric clamp combination with structural simplicity, self-indication capability, and clamp stability.

### FIELD

The present disclosure relates to a fixture, a robotic fixture including the same, and a method for clamping a turnover box.

The stacking device is used to stack the boxes, bags and barrels on the pallet according to a certain arrangement for automatic stacking. It can be stacked in multiple layers and then pushed out, which is convenient for forklift transportation to the warehouse for storage.

Palletizing robots are widely used in food, beverage, beer, automatic logistics and other industries. Palletizing robots greatly save labor and make palletizing operations more flexible, accurate and stable.

In order to adapt to different industrial requirements, the general palletizing robot fixture needs to be customized according to customer needs. The mechanical structure design of the fixture has some common features, that is, the center of the fixing mechanism and the clamping mechanism are symmetrical. For example, the cylinder with specific stroke is used as the driving force to drive and control the aligned clamping claw to clamp materials.

However, the disadvantages of this kind of general design are also very obvious: the fixture of general structure and even the compound functional fixture designed to adapt to more working conditions are usually taking the mechanical structure design of central symmetry. Then, the fixture must meet the strict requirements for symmetrical clamping of materials, so it cannot adapt to the application environment of materials with complex structure and even complex stacking conditions, resulting in the problems of limited adaptive ability and poor flexibility. The quality of the fixture directly affects the working ability, quality, efficiency and cost of the palletizing robot.

### SUMMARY

In view of the above problems, the present disclosure provides an improved fixture and a robotic fixture including the fixture, and a method for clamping a turnover box.

In a first aspect of the disclosure, a fixture is provided that comprising: a corner fixture assembly configured to support a turnover box at a top corner of the turnover box, the corner fixture assembly comprising a corner positioning block and a support, the corner positioning block abutting an upper surface of the top corner of the turnover box and an inner surface of a wall of the turnover box when the corner fixture assembly supports the turnover box. a drive mechanism comprising a first drive rail and a second drive rail on a plane, the first drive rail extending from the corner fixture assembly in a first direction, the second drive rail extending from the corner fixture assembly in a second direction different from the first direction; a first side fixture assembly movable along the first drive rail and a second side fixture assembly movable along the second drive rail, the first side fixture assembly and the second side fixture assembly being configured to support the turnover box at the walls of the turnover box adjacent to the top corner and each comprising a side positioning block and a support, the side positioning blocks abutting an upper surface of the wall of the turnover box and an inner surface of the wall when the corresponding one of the first side fixture assembly and the second side fixture assembly supports the turnover box.

In a second aspect of the disclosure, a method for clamping a turnover box is provided that clamping the turnover box at a top corner of the turnover box using a corner fixture assembly, the corner fixture assembly comprising a corner positioning block and a support, the corner positioning block abutting an upper surface of the top corner of the turnover box and an inner surface of a wall of the turnover box when the corner fixture assembly supports the turnover box; and clamping the turnover box at the walls of the turnover box adjacent to the top corner using a first side fixture assembly and a second side fixture assembly, the first side fixture assembly being movable along a first drive rail extending from the corner fixture assembly in a first direction, the second side fixture assembly being movable along a second drive rail extending from the corner fixture assembly in the second direction different from the first direction, the first side fixture assembly and the second side fixture assembly each comprising a side positioning block and a support, the side positioning blocks abutting an upper surface of the wall of the turnover box and an inner surface of the wall when the corresponding one of the first side fixture assembly and the second side fixture assembly supports the turnover box.

In a third aspect of the disclosure, a robotic fixture is provided that comprises the fixture according to the first aspect of the disclosure.

By using an embodiment in accordance with the present disclosure, a fixture is provided that has a combination of a plurality of fixture assemblies arranged asymmetrically, capable of clamping an object in an asymmetric clamp position, thus accommodating a complex application environment, disassembling a complex stack, and the fixture having a plurality of fixture assemblies capable of providing a robust clamp on the turnover box in both horizontal and vertical directions. Each of the plurality of fixture assemblies is positioned using a positioning block structure, is simple in construction, requires no additional sensors, and the fixture can also include cameras that can be disposed at different positions to flexibly clamp according to different situations of the turnover box.

It is understood that the Summary is not intended to identify key or essential features of the embodiments of the disclosure nor is it intended to be used to limit the scope of the disclosure. Other features of the present disclosure will become apparent from the following description.

### BRIEF DESCRIPTION OF THE DRAWINGS

The foregoing and other objects, features and advantages of the disclosure will become more apparent from the following more particular descriptions of exemplary embodiments of the disclosure as illustrated in the accompanying drawings. The same or similar reference numbers are used throughout the drawings to refer to the same or like portions.

FIG. 1 illustrates a schematic view of a fixture according to one embodiment of the present disclosure;

FIG. 2 shows a detailed diagram of the fixture;

FIG. 3 shows a block diagram of a side fixture assembly of a fixture;

FIG. 4 illustrates a schematic view of the side fixture assembly when supporting the turnover box;

FIG. 5 shows a bottom view of the corner fixture assembly of the fixture;

FIG. 6 illustrates a schematic view of the corner fixture assembly when supporting the turnover box;

FIG. 7 shows a bottom view of the fixture;

FIG. 8 shows a block diagram of the drive mechanism of the fixture; and

FIG. 9 illustrates a robotic fixture including a fixture.

### DETAILED DESCRIPTION OF EMBODIMENTS

Preferred embodiments of the present disclosure will now be described more fully hereinafter with reference to the accompanying drawings. While preferred embodiments of the disclosure are shown in the drawings, it is to be understood that the disclosure may be embodied in various forms and should not be limited by the embodiments set forth herein. Rather, these embodiments are provided such that this disclosure will be thorough and complete, and will fully convey the scope of the disclosure to those skilled in the art.

As used herein, the term “comprising” and variations thereof mean open-ended inclusion, i.e., “comprising but not limited to”. The term “or” means “and/or” unless specifically stated otherwise. The term “based on” means “based at least in portion on”. The terms “an example embodiment” and “one embodiment” mean “at least one example embodiment”. The term “another embodiment” means “at least one additional embodiment”. The terms “first”, “second”, and so forth, may refer to different or the same object. Other explicit and implicit definitions may be included below.

The present disclosure provides fixture, robotic fixture including the same, and a method for clamping a turnover box. The fixture of the present disclosure includes a plurality of fixture assemblies arranged in an asymmetrical manner, capable of supporting objects by clamping only one side of the object without the use of symmetrical fixtures, having the advantage of structural simplicity, self-indication capability, and clamp stability.

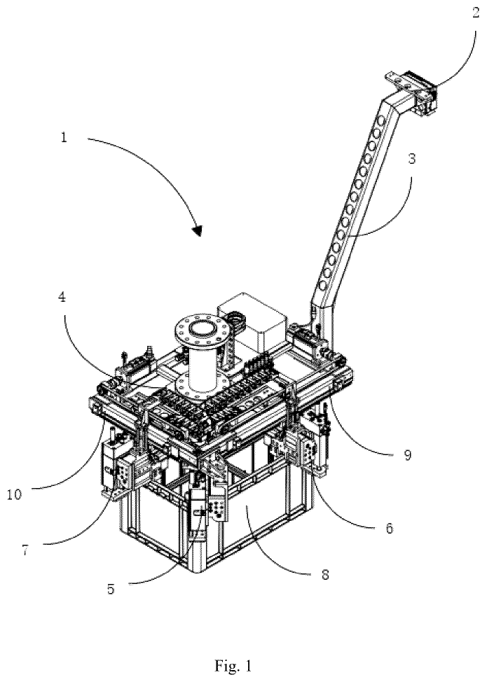

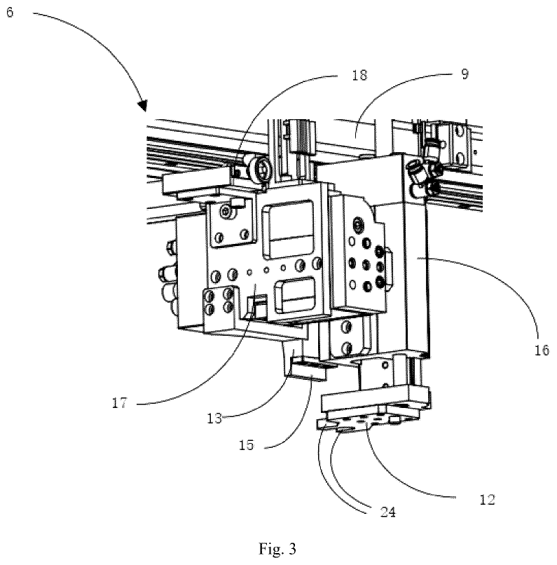

FIG. 1 illustrates a schematic view of a fixture 1 according to one embodiment of the present disclosure. The fixture 1 includes a drive mechanism 4, a corner fixture assembly 5, a first side fixture assembly 6, and a second side fixture assembly 7. The corner fixture assembly 5 is a datum positioning assembly that remains stationary relative to the fixture 1. In one embodiment, the corner fixture assembly 5 may be secured to the drive mechanism 4. The specific structure of the corner fixture assembly 5 will be described in detail below in connection with FIGS. 3-6.

The drive mechanism 4 is a main body portion of the fixture 1, which in one embodiment may be a frame structure for attaching various components of the fixture 1, in particular the drive mechanism 4 may be a rectangular frame structure. The drive mechanism 4 includes at least a first drive rail 9 and a second drive rail 10 on a plane for guiding the first side fixture assembly 6 and the second side fixture assembly 7, respectively. The first drive rail 9 extends from the corner fixture assembly 1 in a first direction and the second drive rail 10 extends from the corner fixture assembly 1 in a second direction that is different from the first direction. In actual operation, since the objects that need to be clamped (e. g., turnover box 8 in FIG. 1) are mostly cubes, in one embodiment, the first direction is perpendicular to the second direction.

The first side fixture assembly 6 and the second side fixture assembly 7 may move along the first drive rail 9 and the second drive rail 10, respectively. In one embodiment, the first side fixture assembly 6 and the second side fixture assembly 7 may be attached to the drive mechanism 4. The first side fixture assembly 6 and the second side fixture assembly 7 are used to clamp two sides of the object adjacent to the top corner after the corner fixture assembly 5 clamps the top corner of the object (the turnover box 8 in FIG. 1) to determine the clamp reference position. To accommodate the size of the object being clamped, the first side fixture assembly 6 and the second side fixture assembly 7 may move along the first drive rail 9 and the second drive rail 10, respectively. The first side fixture assembly 6 and the second side fixture assembly 7 may be manually positioned, or the first side fixture assembly 6 and the second side fixture assembly 7 may also be driven via the drive mechanism 4. For ease of replacement, in one embodiment, the first side fixture assembly 6 and the second side fixture assembly 7 are identical. Specific configurations of the first side fixture assembly 6 and the second side fixture assembly 7 will be described in detail below in connection with FIGS. 3-6.

In an automated clamp scenario, in order to identify an object (in FIG. 1, turnover box 8), fixture 1 also includes a camera 2. The camera 2 is used to identify the position of the object and to determine the size of the object. For objects having a standard gauge, such as the turnover box 8, in one embodiment, the camera 2 may identify the type of the turnover box 8 to determine the size of the turnover box 8 for adaptively adjusting the position of the first side fixture assembly 6 and the second side fixture assembly 7 on the first drive rail 9 and the second drive rail 10, respectively. In yet another embodiment, to facilitate clamping of the object by the fixture assembly, the camera 2 may identify a location on the turnover box 8 that is easy to clamp, such as a ridge protruding from the outer side of the turnover box 8. As shown in FIG. 1, the camera 2 may be connected to the drive mechanism 4 via a mechanical rod 3 for taking the entire working scene. In one embodiment, the camera 2 may also be disposed at other locations of the drive mechanism 4 as desired.

As shown in FIG. 1, upon clamping an object, first using the corner fixture assembly 5 to clamp the turnover box 8 at the top corner of the turnover box 8, and then clamp the two walls of the turnover box 8 adjacent to the top corner with the first side fixture assembly 6 and the second side fixture assembly 7. In one embodiment, the turnover box 8 may be identified by the camera 2, and the corner fixture assembly 5, the first side fixture assembly 6, and the second side fixture assembly 7 may clamp the turnover box based at least on the identification of the turnover box 8 by the camera 2.

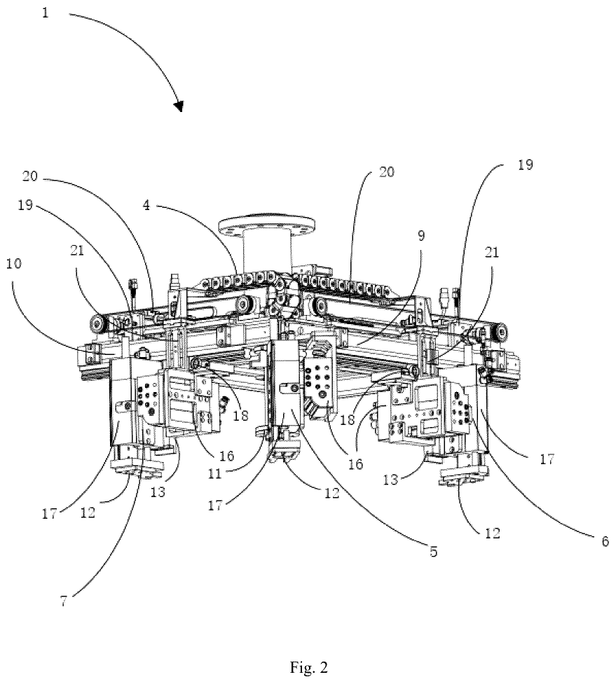

FIG. 2 shows a detailed block diagram of a fixture. As can be seen in FIG. 2, the corner fixture assembly 5 is secured to the drive mechanism 4, the first side fixture assembly 6 and the second side fixture assembly 7 are connected to the drive mechanism 4 by a connection plate 21 to move along the first drive rail 9 and the second drive rail 10, respectively. In one embodiment, the first side fixture assembly 6 and the second side fixture assembly 7 may be operated manually to move along the first drive rail 9 and the second drive rail 10, respectively. In yet another embodiment, the first side fixture assembly 6 and the second side fixture assembly 7 may be driven by the drive mechanism 4.

As shown in FIG. 2, the corner fixture assembly 5, the first side fixture assembly 6, and the second side fixture assembly 7 each include a positioning portion and a support portion. The positioning portion of the corner fixture assembly 5 is a corner positioning block 11, and the positioning portion of the first side fixture assembly 6 and the second side fixture assembly 7 is a side positioning plate 13. The corner positioning block 11 and the side positioning plate 13 have the same function, both for determining the supporting position of the supporting portion against the upper surface and the inner surface of the turnover box when the corresponding fixture assembly clamps the turnover box, and preventing horizontal or vertical movement of the object relative to the fixture assembly in the supporting position. The support portions of the corner fixture assembly 5, the first side fixture assembly 6, and the second side fixture assembly 7 each include a support 12 and a drive portion for driving the support 12.

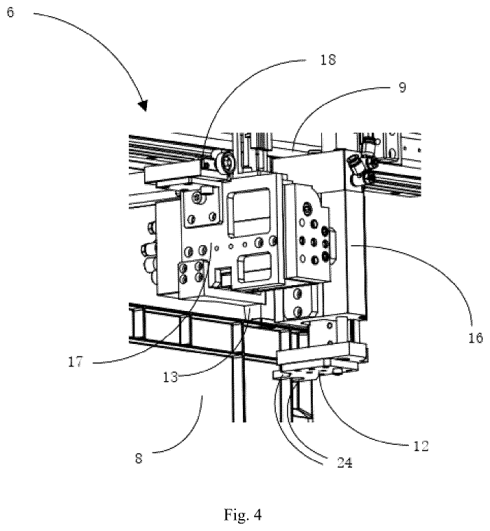

During operation, the support 12 of the corner fixture assembly 5 is driven with the drive portion of the corner fixture assembly 5 to support the top corner of the object when the top corner of the object is first positioned with the corner positioning block 11 of the corner fixture assembly 5, the corner positioning block 5 abuts the upper and inner surfaces of the top corner of the object. The supports 12 of the first side fixture assembly 6 and the second side fixture assembly 7 are then driven with the drive portions of the first side fixture assembly 6 and the second side fixture assembly 7 to support the side walls of the object with the side positioning plate 13. By sequentially support portions of the object in this manner, unsuccessful clamping due to improper mating of the fixture assemblies may be prevented, thereby increasing clamp efficiency and enhancing clamp stability. And this clamping approach requires only one side of the object to be clamped, so this manner of clamping is applicable regardless of how the object is placed. Specific configurations of the fixture assembly will be described in detail below with respect to FIGS. 3-4 as an example of the first fixture assembly 6.

FIG. 3 shows a block diagram of the first side fixture assembly 6 of the fixture 1. The first side fixture assembly 6 includes a side positioning plate 13, a support 12, and a first cylinder 16 and a second cylinder 17 for driving the support 12. Side positioning plate 13 is used to locate the sides of the object. In one embodiment, the side positioning plate 13 further includes a positioning plate 15 protruding from the bottom thereof, the portion of the bottom of the side positioning plate 13 abutting against the upper surface of the side wall of the object when the side of the object is positioned, the side wall of the positioning plate 15 abutting the inner surface of the side wall of the object, at which the side positioning plate 13 abuts the side wall of the object in both the horizontal and vertical directions such that the object does not slide relative to the side positioning plate 13 in both the horizontal and vertical directions.

As shown in FIG. 3, the support portion of the side fixture assembly 6 includes a support 12, a first cylinder 16, and a second cylinder 17. The first cylinder 16 is connected to the support 12 and the second cylinder 17 is connected to the first cylinder 16. The first cylinder 16 is configured to drive the support 12 to move in a first direction to switch the support 12 between a support position and a first release position. In one embodiment, the first cylinder 16 is a vertical cylinder and the first direction is a vertical direction and the first cylinder 16 drives the support 12 to move up and down. When it is desired to move the side fixture assembly 6, the first cylinder 16 is released so that the support 12 is in a first release position at the bottom; when it is desired to clamp the object, the first cylinder 16 is tightened so that the support 12 is raised to a support position that supports the object. The second cylinder 17 is configured to drive the first cylinder 16 and the support 12 together to move in a second direction different from the first direction to switch the first cylinder 16 between the loaded position and the second release position. In one embodiment, the second cylinder 17 is a horizontal cylinder and the second direction is a horizontal direction perpendicular to the first direction, the second cylinder 17 driving the first cylinder 17 and the support 12 to move horizontally. When it is desired to move the side fixture assembly 6, the second cylinder 17 is released so that the first cylinder 16 is in a second released position that is farther from the object; when it is desired to clamp the object, the second cylinder 17 is tightened so that the first cylinder 16 moves to a loading position where the support 12 is to be lifted. In one embodiment, the drive portion may also employ other drive means other than a cylinder, such as a servo motor, etc., as desired. The manner in which the positioning plate and the support of the fixture assembly of the present disclosure cooperate, in comparison to conventional clamping approaches, has a variety of benefits, such as using a positioning plate to determine the clamping position, positioning precision, and avoiding the use of additional positioning sensors; using the support to support the object, lifting the support load relative to a conventional fixture, and reducing damage to the object during clamping; driving the support with two cylinders, structural simplicity, avoiding the occurrence of a clamp failure.

In one embodiment, to accommodate the structure of the turnover box, the support 12 is a fork that includes at least two teeth 24 that can place the vertical ridge of the outer surface of the turnover box in the space between the two teeth 24 for supporting at least two horizontal ridges separated by the vertical ridge, improving support precision and stability.

The clamping step of the side fixture assembly will be described in detail in connection with FIG. 4.

FIG. 4 shows a schematic view of the side fixture assembly when supporting the turnover box 8. When the first side fixture assembly 6 is moved on the first drive rail 9, the support 12 is in the first release position and the first clamp 16 is in the second release position.

When the position of the first side fixture assembly 6 on the drive rail 9 is determined, the second cylinder 17 is operated to place the first clamp 16 in the loaded position, placing the support directly below the position to be supported. In particular, in one embodiment, the support 12, which is a fork element, places the vertical ridge of the turnover box 8 between the two teeth 24 of the support 12 so as to raise the support 12 along the vertical ridge during lifting, increasing the precision of support. When the support is directly below the position to be supported, the first cylinder 16 is operated to place the support 12 in the support position, at which the support 12 is raised against the horizontal ridges of the turnover box 8 to support the turnover box. With respect to the operation of conventional fixtures, the fixture operation of the embodiments of the present disclosure requires less steps, with simplicity, and reliability.

Referring also to FIGS. 3 and 4, in one embodiment, during operation, in order for more stable clamping, the first side fixture assembly 6 needs to be secured in the position of the first drive rail 9, the first side fixture assembly 6 also has a lock 18 for locking the position of the side fixture assembly on the respective drive rail. In one embodiment, the lock 18 may be a manual lock that manually locks the first side fixture assembly 6 upon determining that the first side fixture assembly 6 reaches the proper position. In one embodiment, the lock may also be an automatic lock that automatically locks when the first side fixture assembly 6 is driven a suitable distance.

The structure and operation of the second side fixture assembly 7 is similar to the first side fixture assembly 6 and will not be described again for the sake of clarity. In one embodiment, the first side fixture assembly 6 and the second side fixture assembly 7 may be identical for ease of manufacture and installation.

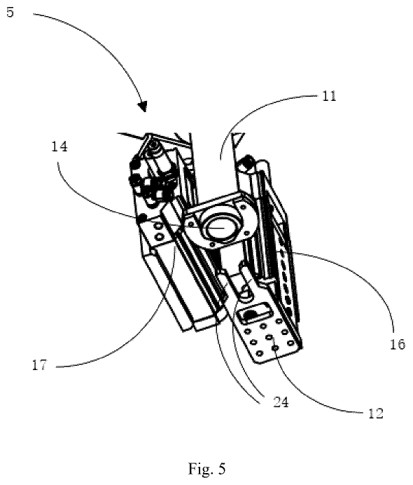

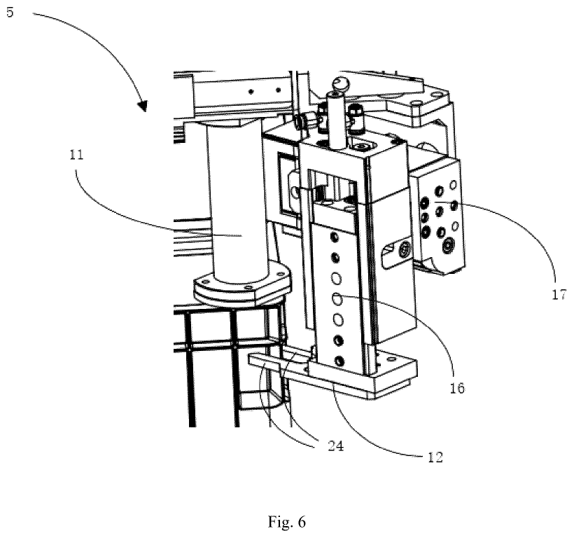

FIG. 5 shows a bottom view of the corner fixture assembly of the fixture. The support portion of the corner fixture assembly 5 is similar to the first side fixture assembly 6, and thus will not be described again. A corner positioning plate 11 is used to locate the top corner of the object. In one embodiment, the corner positioning block 11 further includes a positioning post 14 projecting from the bottom thereof, wherein the positioning post 14 has two sides at an angle to each other, optionally with the two sides being at a 90° angle in the box of a clamping the turnover box. In positioning the top corner of the object, a portion of the bottom of the corner positioning block 11 abuts against the upper surface of the top corner of the object, the positioning post 14 abuts the inner surface of the top corner of the object, with the two sides of the positioning post 14 abutting the inner surfaces of the two sidewalls adjacent the top corner, respectively, at which the location of the corner positioning plate 11 with the top corner of the object is fixed. At this time, the relative position of the object to the fixture 1 is fixed by the clamping of the top corner by the support portion of the corner fixture assembly 5. In contrast to conventional techniques, the present disclosure employs clamping an object with an corner fixture assembly firstly, ensuring that the fixture does not produce a relative displacement with the object during a subsequent clamp, increasing the stability of the clamp, and positioning the clamp position by the corner fixture assembly such that the positioning of the side fixture assembly is facilitated, thereby reducing operational difficulties. The clamping step of the corner fixture assembly will be described in detail in connection with FIG. 6.

FIG. 6 shows a schematic view of the corner fixture assembly when supporting the turnover box. The specific operation of the corner fixture assembly 5 is similar to the first side fixture assembly 6, and thus will not be described in further detail. During clamping, the corner fixture assembly 5 and the first side fixture assembly 6 differ in that the support 12 of the corner clamp assembly 5 supports the ridges of the outer surfaces of the two side walls adjacent the top corner. In one embodiment, when the support 12 is a fork, the two teeth 24 of the support 12 simultaneously support different ridges of the two sidewalls adjacent to the top corner, respectively.

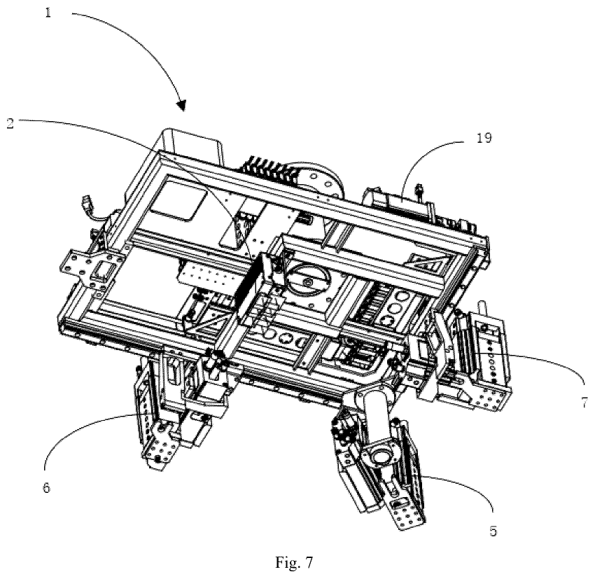

FIG. 7 shows a bottom view of the fixture. In one embodiment, for convenient identification, camera 2 may be disposed on the surface of drive mechanism 4 facing an object. Setting the camera on the surface facing the object can identify the entirety of the object and can identify the actual clamp position of the three fixture assemblies on the object, which can make the identification more precise, and facilitate adjustment and control of the fixture. In the embodiment with the camera 2, the position of the first side fixture assembly 6 and the second side fixture assembly 7 on the first drive rail 9 and the second drive rail 10, respectively, may be determined based on the identification of the object by camera 2.

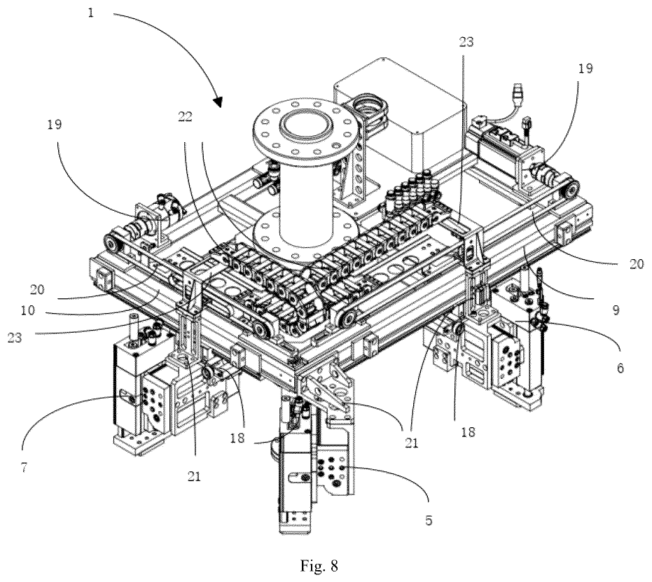

Drive structure 4 is described in detail below in conjunction with FIG. 8.

FIG. 8 shows a block diagram of the drive mechanism of the fixture. The drive mechanism 4 includes at least two drive rails, a first drive rail 9 and a second drive rail 10 in FIG. 8, the first side fixture assembly 6 and the second side fixture assembly 7 moving on the first drive rail 9 and the second drive rail 10, respectively. The first drive rail 9 and the second drive rail 10 may have any length, as desired. Although the first drive rail 9 shown in FIG. 8 is being longer than the second drive rail 10, in one embodiment, the first and second drive rails 9, 10 may have the same length, in order to increase the flexibility of the fixture 1, it is convenient for the fixture 1 to not switch directions when clamping objects of different sizes. In one embodiment, drive mechanism 4 may have more drive rails depending on actual operation needs or backup. In one embodiment, a drive rail parallel to the first drive rail 9 and the second drive rail 10 may be provided.

In one embodiment, the drive mechanism 4 further includes a drive means 19 for driving the first and second drive rails 9 and 10 and a synchronization belt 20 which conducts the driving force. In one embodiment, for ease of operation, the drive device 19 may be a rotating cylinder. In yet another embodiment, to operating more precise, the drive device 19 may also be a servo motor. As shown in FIG. 8, the drive unit 19 is coupled to the synchronization belt 20 by means of a coupling means to rotate the synchronization belt 20. The first side fixture assembly 6 and the second side fixture assembly 7 are connected to the synchronization belt 20 by a connecting plate 21, which is driven to move on the first drive rail 9 or the second drive rail 10 via the synchronization belt 20. In this manner of coupling, the distance of movement of the first side fixture assembly 6 and the second side fixture assembly 7 may be lengthened, and such that the load on the first side fixture assembly 6 and the second side fixture assembly 7 does not directly affect the drive device 19. In one embodiment, for ease of repair and replacement, the first side fixture assembly 6 and the second side fixture assembly 7 are removably connected to the drive mechanism 4 via the connection plate 21. In one embodiment, when the fixture 1 includes the camera 2, the object may be identified by the camera 2, and the drive mechanism 19 is operated to move the first side fixture assembly 6 and the second side fixture assembly 7 a distance to reach the clamping position based at least on the identification of the object.

According to one embodiment, the drive mechanism 4 further includes a pull chain 22 for conducting cables necessary for the first side fixture assembly 6 and the second side fixture assembly 7 for movement following the first side fixture assembly 6 and the second side fixture assembly 7 to prevent cable being broken. The drive mechanism 4 further includes a pressure plate 23 connected to the connecting plate 21 and movable with the first side fixture assembly 6 or the second side fixture assembly 7, the pressure plate 23 for flattening the pull chain 22, preventing the pull chain 22 from interfering with the movement of the first side fixture assembly 6 and the second side fixture assembly 7. As compared to conventional clamps, components of the drive mechanism of the fixture of the present disclosure are removable, convenient to replace, and with lower operational difficulty and higher reliability.

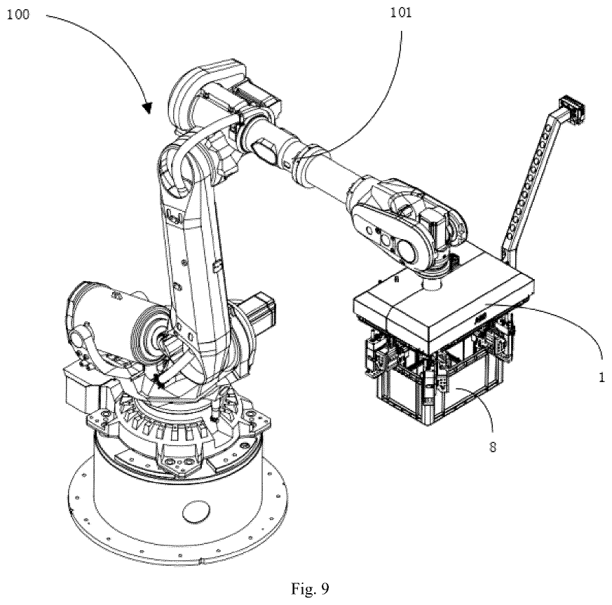

FIG. 9 illustrates a robotic fixture 100 including a fixture 1 for automated palletization of the turnover box. The robotic fixture 100 has a fixture robot arm 101, wherein the robot arm 101 is connected to a fixture 1 for moving the fixture 1 to a location in which an object is clamped. In one embodiment, the object can be clamped by manual remote control of the robotic fixture 100. In one embodiment, the robotic fixture 100 also includes a computing device that, when a camera is present in the fixture 1, may identify the object by the camera, calculate a particular clamp location, and drive the fixture 1 to clamp the object. In one embodiment, the robotic fixture 100 further includes a storage device in which the shape data of the object is stored (e.g., the size of the turnover box), when the camera is present in the fixture 1, the object may be identified by the camera, and the identified data is transmitted into the computing device, the computing device drive the side fixture assembly in the fixture 1 to move to the proper position by comparing the identified dimensional data to the shape data in the storage device, and the object is clamped by the fixture 1. The body portion of the robotic fixture 100 according to embodiments of the present disclosure is only used to move the fixture 1, while the specific clamping operation is done by the fixture 1 itself, so the appropriate clamp 1 may be replaced on the basis of a different application scenario.

It is to be understood that the above detailed embodiments of the disclosure are merely for the purpose of illustrating or explaining the principles of the disclosure and are not limiting of the disclosure. Therefore, any modifications, equivalents, improvements within the spirit and principles of the present disclosure are intended to be included within the scope of the present disclosure. Also, it is intended that the appended claims cover all changes and modifications that fall within the scope and range of equivalents of the claims.

1. A fixture comprising:
a corner fixture assembly configured to support a turnover box at a top corner of the turnover box, the corner fixture assembly comprising a corner positioning block and a support, the corner positioning block abutting an upper surface of the top corner of the turnover box and an inner surface of a wall of the turnover box when the corner fixture assembly supports the turnover box;
a drive mechanism comprising a first drive rail and a second drive rail on a plane, the first drive rail extending from the corner fixture assembly in a first direction, the second drive rail extending from the corner fixture assembly in a second direction different from the first direction;
a first side fixture assembly movable along the first drive rail and a second side fixture assembly movable along the second drive rail, the first side fixture assembly and the second side fixture assembly being configured to support the turnover box at the walls of the turnover box adjacent to the top corner and each comprising a side positioning block and a support, the side positioning blocks abutting an upper surface of the wall of the turnover box and an inner surface of the wall when the corresponding one of the first side fixture assembly and the second side fixture assembly supports the turnover box.

2. The fixture of claim 1, wherein the corner positioning block comprises a positioning post projecting from a bottom thereof, wherein the positioning post comprises two sides at an angle to each other, the two sides of the positioning post abutting an inner surface of two of the walls adjacent to the top corner, respectively, when the corner fixture assembly supports the turnover box.

3. The fixture of claim 1, wherein the side positioning block comprises a positioning plate projecting from a bottom thereof, the side of the positioning plate of the side positioning block abutting an inner surface of the wall of the turnover box when the corresponding one of the first side fixture assembly and the second side fixture assembly supports the turnover box.

4. The fixture of claim 1, wherein the support is in a support position when the corresponding one of the corner fixture assembly, the first side fixture assembly, and the second side fixture assembly support the turnover box, wherein an upper surface of the support abuts a ridge on the wall of the turnover box.

5. The fixture of claim 4, wherein the support of the corner fixture assembly, the first side fixture assembly, and the second side fixture assembly are fork-shape member comprising at least two teeth.

6. The fixture of claim 4, wherein the corner fixture assembly, the first side fixture assembly, and the second side fixture assembly each comprises a first cylinder coupled to the support and a second cylinder coupled to the first cylinder, wherein the first cylinder is configured to drive the support to move in a first moving direction to switch the support between the support position and a first release position, the second cylinder configured to drive the first cylinder and the support to move in a second moving direction different from the first moving direction to switch the first cylinder between a loaded position and a second release position.

7. The fixture of claim 1, wherein the first side fixture assembly and the second side fixture assembly each comprises a lock for locking a location of the first side fixture assembly and the second side fixture assembly on the first drive rail and the second drive rail, respectively.

8. The fixture of claim 7, wherein the locations of the first side fixture assembly and the second side fixture assembly on the first drive rail and the second drive rail, respectively, are adjustable manually.

9. The fixture of claim 1, wherein the drive mechanism comprises drive means and synchronization belts for the first drive rail and the second drive rail, the drive means being configured to drive the first side fixture assembly and the second side fixture assembly to move along the first drive rail and the second drive rail, respectively, via the synchronization belts.

10. The fixture of claim 9, wherein at least one of the drive means is a motor and/or a rotating cylinder.

11. The fixture of claim 9, wherein the drive mechanism further comprises connection plates coupling the first side fixture assembly and the second side fixture assembly with the drive mechanism, respectively, the first side fixture assembly and the second side fixture assembly removably coupled to the drive mechanism via the connection plates.

12. The fixture of claim 1, further comprising at least one camera configured to identify the turnover box, wherein the corner fixture assembly, the drive mechanism, the first side fixture assembly and a second side fixture assembly are configured to operate at least based on the identification of the turnover box.

13. The fixture of claim 12, wherein the at least one camera is connected to the drive mechanism via a mechanical rod or is disposed on the side of a drive mechanism facing the turnover box.

14. A robotic fixture, comprising:
a robotic arm; and
the fixture of claim 1 coupled to the robotic arm.

15. A method for clamping a turnover box, comprising:
clamping the turnover box at a top corner of the turnover box using a corner fixture assembly, the corner fixture assembly comprising a corner positioning block and a support, the corner positioning block abutting an upper surface of the top corner of the turnover box and an inner surface of a wall of the turnover box when the corner fixture assembly supports the turnover box; and
clamping the turnover box at the walls of the turnover box adjacent to the top corner using a first side fixture assembly and a second side fixture assembly, the first side fixture assembly being movable along a first drive rail extending from the corner fixture assembly in a first direction, the second side fixture assembly being movable along a second drive rail extending from the corner fixture assembly in the second direction different from the first direction, the first side fixture assembly and the second side fixture assembly each comprising a side positioning block and a support, the side positioning blocks abutting an upper surface of the wall of the turnover box and an inner surface of the wall when the corresponding one of the first side fixture assembly and the second side fixture assembly supports the turnover box.

16. The method of claim 15, wherein clamping the turnover box using the corner fixture assembly, the first side fixture assembly, and the second side fixture assembly further comprises using an upper surface of the support to abut a ridge on the wall of the turnover box.

17. The method of claim 15, wherein the corner fixture assembly, the first side fixture assembly, and the second side fixture assembly each comprises a first cylinder coupled to the support and a second cylinder coupled to the first cylinder, wherein the first cylinder is configured to drive the support to move in a first moving direction to switch the support between the support position and a first release position, the second cylinder is configured to drive the first cylinder and the support to move in a second moving direction to switch the first cylinder between a loaded position and a second release position, wherein clamping the turnover box using an corner fixture assembly, the first side fixture assembly, and the second side fixture assembly further comprises:
controlling the second cylinder to set the first cylinder in the second release position and control the first cylinder to set the support in the first release position;
controlling the second cylinder to set the first cylinder in a loaded position when the corresponding corner positioning block or the side positioning block comprises abutted against the inner surface of the wall of the turnover box;
controlling the first cylinder to set the support in a support position when the first cylinder has been set in the loaded position.

18. The method of claim 15, further comprising:
identifying the turnover box using a camera, wherein clamping the turnover box is at least based on the identification of the turnover box.

19. The method of claim 18, further comprising determining the location of the first side fixture assembly and the second side fixture assembly on the first drive rail and the second drive rail, respectively, at least based on the identification of the turnover box.

20. The method of claim 19, further comprising driving the first side fixture assembly and the second side fixture assembly to reach the determined locations of the first side fixture assembly and the second side fixture assembly on the first drive rail and the second drive rail, respectively, using drive means and synchronization belts.
